(19) United States
(12) Patent Application Publication
(10) Pub. No.: US 2025/0376629 A1
(43) Pub. Date: Dec. 11, 2025

(54) A HYDROCARBON COMPONENT

(71) Applicant: Neste Oyj, Espoo (FI)

(72) Inventors: Eetu KARI, Porvoo (FI); Ulla KIISKI, Porvoo (FI); Markku KURONEN, Porvoo (FI); Kaisa LAMMINPÄÄ, Porvoo (FI); Petro SIREGAR, née SILVONEN, Porvoo (FI)

(73) Assignee: Neste Oyj, Espoo (FI)

(21) Appl. No.: 18/876,282

(22) PCT Filed: Jun. 30, 2023
(86) PCT No.: PCT/FI2023/050416

§ 371 Date: Dec. 18, 2024

(30) Foreign Application Priority Data
Jun. 30, 2022 (FI) 20225603
Jun. 30, 2022 (FI) 20225604
Jun. 30, 2022 (FI) 20225605
Jun. 30, 2022 (FI) 20225606
Jun. 30, 2022 (FI) 20225607
Jun. 30, 2022 (FI) 20225608
Jun. 30, 2022 (FI) 20225609
Dec. 2, 2022 (FI) 20226071
Jun. 20, 2023 (FI) 20235691

(51) Int. Cl. C10G 65/12

(52) U.S. Cl. CPC C10G 65/12; C10G 2300/1081; C10G 2300/302; C10G 2300/304; C10G 2300/307; C10G 2400/04; C10G 2400/08; C10L 2200/0476

(57) ABSTRACT

Herein is disclosed a hydrocarbon component including predominantly C15-C22 n-paraffins, C15-C22 mono-branched i-paraffins and C15-C22 multiple-branched i-paraffins. In the hydrocarbon component, a weight ratio of i-paraffins to n-paraffins is higher than in known hydrocarbon components. Due to improved properties the hydrocarbon component is usable in a wide range of applications, such as in arctic grade diesel fuels, wherein it can be incorporated in higher proportions.

### TECHNICAL FIELD

The present disclosure generally relates to processes producing fuel components and products thereof. The disclosure relates particularly, though not exclusively, to a novel hydrocarbon component, mainly to a renewable diesel fuel component, obtainable from renewable feed.

### BACKGROUND

This section illustrates useful background information without admission of any technique described herein representative of the state of the art.

There is an ongoing need to reduce greenhouse gas emissions and/or carbon footprint inter alia in transportation. Accordingly, interest towards renewable transportation fuels and replacements for various petrochemicals has been growing.

Processes for producing fuel components from renewable raw materials have been proposed. Non-fossil diesels, such as hydrotreated vegetable oil (HVO), renewable diesels, and in particular fatty acid methyl esters (FAME) have struggled meeting requirements set for cold properties. Measures for improving cold properties, that is lowering the cloud point (CP) and cold filter plugging point (CFPP) given as temperature, have been proposed and winter grades and even arctic grades are now available as at least partly non-fossil diesels. However, lowering CP and/or CFPP has often led to changes in undesired directions in other product characteristics, such as viscosity, density and/or cetane. Generally, viscosity and cold properties are inversely proportional. For example, commercially available fossil arctic grade diesels have relatively low viscosity at 40° C., below 2.000 mm²/s.

However, higher viscosity would be desired as it improves the spraying of the fuel in the fuel system, as long as the viscosity of the fuel meets general requirements of EN590/EN15940 specification (viscosity at 40° C. max. 4.500 mm²/s) or EN590:2022 arctic diesel specifications (viscosity at 40° C. max. 4.000 mm²/s).

There is a continuing need for renewable fuel components having good cold properties. More specifically, there is a need to provide a hydrocarbon component suitable for arctic use, having high cetane number and higher viscosity at 40° C. than conventional fossil arctic grade diesels. Particularly, there is an interest towards producing a hydrocarbon component that could be used in a wide range of applications, such as in fuels, transformer oils, gear oils, solvents, lubricants, heating oils, insulation oils, hydraulic oils, and turbine oils or for power generation.

### SUMMARY

It is an aim to solve or alleviate at least some of the problems related to prior art. An aim is to improve the quality of hydrocarbon components, particularly diesel fuel components, obtainable from renewable sources.

The appended claims define the scope of protection. Any examples and technical descriptions of products, processes and/or uses in the description and/or drawings not covered by the claims are presented not as embodiments of the invention but as examples useful for understanding the invention.

According to a first example aspect, there is provided a hydrocarbon component, preferably a renewable hydrocarbon component, such as a diesel fuel component or renewable diesel fuel component, comprising n-paraffins, mono-branched i-paraffins, and multiple-branched i-paraffins, wherein the sum amount of C15-C22 n-paraffins, C15-C22 mono-branched i-paraffins, and C15-C22 multiple-branched i-paraffins is at least 90 wt-% of the total hydrocarbon component weight, and wherein the weight ratio of C15-C22 i-paraffins to C15-C22 n-paraffins is at least 22:1, preferably at least 24:1, more preferably at least 30:1, even more preferably at least 34:1.

The present inventors have found the present hydrocarbon component and embodiments thereof to provide certain advantages compared to prior art hydrocarbon components, especially renewable hydrocarbon components, such as prior art renewable diesel components. The advantages are related e.g to higher density and higher viscosity at temperatures above zero ° C., combined with excellent cold properties, including good fluidity at subzero temperatures, as discussed in more detail later.

Production of the hydrocarbon component may employ a certain process comprising a combination of hydroisomerisation and hydrocracking of a paraffinic feed. The present hydrocarbon component may be obtained from a process for producing renewable fuel components, the process further comprising recovery of at least an aviation fuel component.

According to a second example aspect there is provided a diesel fuel composition comprising from 1 to 99 vol-%, preferably from 10 to 70 vol-% hydrocarbon component as defined herein of the total diesel fuel composition volume. Surprisingly, high volume share, such as 70 vol-% of the hydrocarbon component in the diesel fuel composition is possible particularly due to the exceptionally high density of the present hydrocarbon component.

According to a third example aspect there is provided use of the present hydrocarbon component in a diesel fuel composition for improving one or more product properties of the diesel fuel composition.

According to a fourth example aspect there is provided use of a hydrocarbon component as defined herein, in feedstock(s) for industrial conversion process(es), preferably in thermal cracking feedstock(s) and/or in catalytic cracking feedstock(s), in transformer oil(s), in heat-transfer medium or media, in switchgear oil(s), in shock absorber oil(s), in insulating oil(s), in hydraulic fluid(s), in gear oil(s), in transmission fluid(s), in degreasing composition(s), in penetrating oil(s), in anticorrosion composition(s), in multipurpose oil(s), in metal working fluid(s), in rolling oil(s) especially for aluminium, in cutting oil(s), in drilling fluid(s), in solvent(s), in lubricant(s), in extender oil(s), in carrier(s), in dispersant composition(s), in demulsifier(s), in extractant(s), in paint composition(s), in coating fluid(s) or paste(s), in adhesive(s), in resin(s), in varnish(es), in printing paste(s) or ink(s), in detergent(s), in cleaner(s), in plasticizing oil(s), in turbine oil(s), in hydrophobization composition(s), in agriculture, in crop protection fluid(s), in construction, in concrete demoulding formulation(s), in electronics, in medical appliance(s), in composition(s) for car, electrical, textile, packaging, paper, cosmetic and/or pharmaceutical industry, and/or in manufacture of intermediate(s) therefor. In said use(s) the excellent physico-chemical characteristics may be utilised and at the same time, the preferred renewable character may be appreciated.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 illustrates schematically an example embodiment of a process for producing the present hydrocarbon component.

FIG. 2 illustrates schematically another example embodiment of a process for producing the present hydrocarbon component.

### DETAILED DESCRIPTION

In the following description, like reference signs denote like elements or steps.

All standards referred to herein are the latest revisions available at the filing date, unless otherwise mentioned.

Unless otherwise stated, regarding distillation characteristics, such as initial boiling points (IBP), final boiling points (FBP), T5 temperature (5 vol-% recovered), T95 temperature (95 vol-% recovered), and boiling ranges, reference is made to EN ISO 3405-2019. IBP is the temperature at the instant the first drop of condensate falls from the lower end of the condenser tube, and FBP is the maximum thermometer reading obtained during the test, usually occurring after the evaporation of all liquid from the bottom of the flask. For boiling point distribution reference may also be made to GC-based method (simdis) ASTM D2887-19e1, or for gasoline range hydrocarbons to ASTM D7096-19.

As used in the context of this disclosure, diesel fuel component refers to hydrocarbon compositions suitable for use in fuel compositions meeting standard specifications for diesel fuels, such as specifications laid down in EN 590:2022 or in EN 15940:2016+A1:2018+AC:2019. Typically, such diesel fuel components boil, i.e. have IBP and FBP, within a range from about 160° C. to about 380° C., as determined according to EN ISO 3405-2019.

As used in the context of this disclosure, aviation fuel component refers to hydrocarbon compositions suitable for use in fuel compositions meeting standard specifications for aviation fuels, such as specifications laid down in ASTM D7566-21. Typically, such aviation fuel components boil i.e. have IBP and FBP within a range from about 100° C. to about 300° C., such as within a range from about 150° C. to about 300° C., as determined according to EN ISO 3405-2019.

As used in the context of this disclosure, gasoline fuel component or naphtha refers to hydrocarbon components suitable for use in fuel compositions meeting standard specifications for gasoline fuels, such as specifications laid down in EN 228-2012+A1-2017. Typically, such gasoline fuel components boil, i.e. have IBP and FBP, within a range from about 25° C. to about 210° C., as determined according to EN ISO 3405-2019.

As used in the context of this disclosure, marine fuel component refers to hydrocarbon components suitable for use in fuel compositions meeting standard specifications for marine fuels, such as specifications laid down in ISO 8217-2017. Typically, such marine fuel components boil, i.e. have IBP and FBP, within a range from about 180° C. to about 600° C., such as from about 180° C. to about 400° C., as determined according to EN ISO 3405-2019.

As used herein hydrocarbons refer to compounds consisting of carbon and hydrogen. Hydrocarbons of particular interest in the present context comprise paraffins, n-paraffins, i-paraffins, monobranched i-paraffins, multiple-branched i-paraffins, olefins, naphthenes, and aromatics. Oxygenated hydrocarbons refer herein to hydrocarbons comprising covalently bound oxygen.

As used herein paraffins refer to non-cyclic alkanes, i.e. non-cyclic, open chain saturated hydrocarbons that are linear (normal paraffins, n-paraffins) or branched (isoparaffins, i-paraffins). In other words, paraffins refer herein to n-paraffins and/or i-paraffins.

In the context of the present disclosure, i-paraffins refer to branched open chain alkanes, i.e. non-cyclic, open chain saturated hydrocarbons having one or more alkyl side chains. Herein, i-paraffins having one alkyl side chain or branch are referred to as monobranched i-paraffins and i-paraffins having two or more alkyl side chains or branches are herein referred to as multiple-branched i-paraffins. In other words, i-paraffins refer herein to monobranched i-paraffins and/or multiple-branched i-paraffins. The alkyl side chain(s) of i-paraffins may for example be C1-C9 alkyl side chain(s), preferably methyl side chain(s). The amounts of monobranched and multiple-branched i-paraffins may be given separately. The term “i-paraffins” refers to sum amount of any monobranched i-paraffins and any multiple-branched i-paraffins, if present, indicating the total amount of any i-paraffins present regardless the number of branches. Correspondingly, “paraffins” refers to sum amount of any n-paraffins, any monobranched i-paraffins, and any multiple-branched i-paraffins, if present.

In the context of the present disclosure, olefins refer to unsaturated, linear, branched, or cyclic hydrocarbons, excluding aromatic compounds. In other words, olefins refer to hydrocarbons having at least one unsaturated bond, excluding unsaturated bonds in aromatic rings.

As used herein, cyclic hydrocarbons refer to all hydrocarbons containing cyclic structure(s), including cyclic olefins, naphthenes, and aromatics. Naphthenes refer herein to cycloalkanes i.e. saturated hydrocarbons containing at least one cyclic structure, with or without side chains. As naphthenes are saturated compounds, they are compounds without aromatic ring structure(s) present. Aromatics refer herein to hydrocarbons containing at least one aromatic ring structure, i.e. cyclic structure having delocalized, alternating Ir bonds all the way around said cyclic structure.

In the context of the present disclosure, for compositions boiling at 36° C. or higher (at standard atmospheric pressure), contents of n-paraffins, i-paraffins, monobranched i-paraffins, various multiple-branched isoparaffins, naphthenes, and aromatics are expressed as weight % (wt-%) relative to the degassed weight of the feed, stream, effluent, product, component or sample in question, or, when so defined, as weight-% (wt-%) relative to the (total) weight of paraffins or (total) weight of i-paraffins of the feed, stream, effluent, product, component, or sample in question. Said contents may be determined by GC×GC-FID/GC×GC-MS method, preferably conducted as follows: GC×GC (2D GC) method was run as generally disclosed in UOP 990-2011 and by Nousiainen M. in the experimental section of his Master's Thesis Comprehensive two-dimensional gas chromatography with mass spectrometric and flame ionization detectors in petroleum chemistry, University of Helsinki, August 2017, with the following modifications. The GC×GC was run in reverse mode, using a semipolar column (Rxi17Sil) first and a non-polar column (Rxi5Sil) thereafter, followed by FID detector, using run parameters: carrier gas helium 31.7 cm/sec (column flow at 40° C. 1.60 ml/min); split ratio 1:350; injector 280° C.; Column T program 40° C. (0 min)-5° C./min-250° C. (0 min)-10° C./min-300° C. (5 min), run time 52 min; modulation period 10 sec; detector 300° C. with H₂ 40 ml/min and air 400 ml/min; makeup flow helium 30 ml/min; sampling rate 250 Hz and injection size 0.2 microliters. Individual compounds were identified using GC×GC-MS, with MS-parameters: ion source 230° C.; interface 300° C.; scan range 25-500 amu; event time (sec) 0.05; scan speed 20000. Commercial tools (Shimadzu's LabSolutions, Zoex's GC Image) were used for data processing including identification of the detected compounds or hydrocarbon groups, and for determining their mass concentrations by application of response factors relative to n-heptane to the volumes of detected peaks followed by normalization to 100 wt-%. Olefins were lumped with naphthenes and heteroatomic species with aromatics, unless separately reported. The limit of quantitation for individual compounds of this method is 0.1 wt-%.

In the context of the present disclosure, various characteristics of the feeds, streams, effluents, products, components, or samples are determined according to the standard methods referred to or disclosed herein, as properly prepared. For example, cloud point is determined according to ASTM D 5771-17 from a degassed feed, stream, effluent, product, component, or sample.

In the context of this disclosure, feed(s) to reaction sections, particularly to the first reaction section and/or the second reaction section, are defined so that H₂ possibly fed to the respective reaction section, for example H₂ fed to the hydroisomerisation and/or H₂ fed to the hydrocracking, is excluded from the definition of the feed(s).

As used herein, hydroisomerisation (HI) effluent refers to total HI effluent, degassed HI effluent, or degassed and stabilised HI effluent, as the case may be, and the term HI effluent may encompass each of these.

In the context of this disclosure, CX+ paraffins, CX+ n-paraffins, CX+ i-paraffins, CX+ mono-branched i-paraffins, CX+ multiple-branched i-paraffins, CX+ hydrocarbons, or CX+ fatty acids refer to paraffins, n-paraffins, i-paraffins, mono-branched i-paraffins, multiple-branched i-paraffins, hydrocarbons, or fatty acids, respectively, having a carbon number of at least X, where X is any feasible integer. It is understood that every compound falling within the definition is not necessarily present.

In the context of this disclosure, CY− paraffins, CY− n-paraffins, CY− i-paraffins, CY− mono-branched i-paraffins, CY− multiple-branched i-paraffins, CY− hydrocarbons, or CY− fatty acids refer to paraffins, n-paraffins, i-paraffins, mono-branched i-paraffins, multiple-branched i-paraffins, hydrocarbons, or fatty acids, respectively, having a carbon number of at most Y, wherein Y is any feasible integer. It is understood that every compound falling within the definition is not necessarily present.

In the context of this disclosure, CX_{Y}-CX_{Z} (or CX_{Y} to CX_{Z}) paraffins, CX_{Y}-CX_{Z} n-paraffins, CX_{Y}-CX_{Z} i-paraffins, CX_{Y}-CX_{Z} mono-branched i-paraffins, CX_{Y}-CX_{Z} multiple-branched i-paraffins, CX_{Y}-CX_{Z} hydrocarbons, or CX_{Y}-CX_{Z} fatty acids refer to a range of paraffins, n-paraffins, i-paraffins, mono-branched i-paraffins, multiple-branched i-paraffins, hydrocarbons, or fatty acids, respectively, where X_{Y} and X_{Z} are feasible end-value integers, wherein the carbon numbers within such range is as indicated by the end-value integers and any integers between said end-values, if present. However, paraffins, n-paraffins, i-paraffins, mono-branched i-paraffins, multiple-branched i-paraffins, hydrocarbons, or fatty acids, as the case may be, of all said carbon numbers within said range, particularly at or around the end points are not necessarily present, except when so expressly indicated. On the other hand, isomers, by definition, may comprise several compounds having the same carbon number, such as C15 isomers may comprise methyltetradecanes (different position of the methyl-branch), dimethyltridecanes (different positions of the two methyl-branches), etc, wherein “C15 isomers” comprises the sum amount of all such variants.

Typically, a sum amount as of weight or volume of paraffins, n-paraffins, i-paraffins, mono-branched i-paraffins, multiple-branched i-paraffins, hydrocarbons, or fatty acids, as defined each time, of all carbon numbers included is meant. For example, C15 to C22 n-paraffins refers to any n-paraffins within said range, such as C15, C16, C17, C18, C19, C20, C21, and C22 n-paraffins, even if the content of C15 n-paraffins was zero. In other words, a sum amount is obtainable by addition of 0 (referring to absent C15 n-paraffins) to the sum weight of all other C15 to C22 n-paraffins present.

Isomerisation converts at least a certain amount of n-paraffins to i-paraffins, especially to mono-branched i-paraffins. By (further) raising the isomerization degree, for example by increasing severity of the hydroisomerisation as described hereinafter, more n-paraffins can be converted to i-paraffins, and mono-branched i-paraffins can be converted to multiple-branched i-paraffins, such as di-branched and/or tri-branched i-paraffins, even i-paraffins comprising more than three branches.

As used herein and in the context of the second reaction section, degree of effective cracking refers to cracking that yields non-gaseous (NTP) cracking products, especially as expressed as the ratio of the C8 to C14 hydrocarbon content in the hydrocracking to the C8 to C14 hydrocarbon content in the second reaction section feed.

As used herein, the term renewable refers to compounds or compositions that are obtainable, derivable, or originating from plants and/or animals, including compounds or compositions obtainable, derivable, or originating from fungi and/or algae, in full or in part. As used herein, renewable compounds or compositions may comprise gene manipulated compounds or compositions. Renewable feeds, components, compounds, or compositions may also be referred to as biological feeds, components, compounds, or compositions, or as biogenic feeds, components, compounds, or compositions.

As used herein, the term fossil refers to compounds or compositions that are obtainable, derivable, or originating from naturally occurring non-renewable compositions, such as crude oil, petroleum oil/gas, shale oil/gas, natural gas, or coal deposits, and the like, and combinations thereof, including any hydrocarbon-rich deposits that can be utilized from ground/underground sources. The term circular refers to recycled material typically originating from non-renewable sources. For example, the term circular may refer to recycled material originating from waste plastics.

Said renewable, circular, and fossil compounds or compositions are considered differing from one another based on their origin and impact on environmental issues. Therefore, they may be treated differently under legislation and regulatory framework. Typically, renewable, circular, and fossil compounds or compositions are differentiated based on their origin and information thereof provided by the producer.

Chemically the renewable or fossil origin of any organic compounds, including hydrocarbons, can be determined by suitable method for analyzing the content of carbon from renewable sources e.g. DIN 51637 (2014), ASTM D6866 (2020) or EN 16640 (2017). Said methods are based on the fact that carbon atoms of renewable or biological origin comprise a higher number of unstable radiocarbon (¹⁴C) atoms compared to carbon atoms of fossil origin. Therefore, it is possible to distinguish between carbon compounds derived from renewable or biological sources or raw material and carbon compounds derived from non-renewable or fossil sources or raw material by analyzing the ratio of ¹²C and ¹⁴C isotopes. Thus, a particular ratio of said isotopes can be used as a “tag” to identify a renewable carbon compound and differentiate it from non-renewable carbon compounds. The isotope ratio does not change in the course of chemical reactions. Therefore, the isotope ratio can be used for identifying renewable compounds, components, and compositions and distinguishing them from non-renewable, fossil materials in reactor feeds, reactor effluents, separated product fractions and various blends thereof. Numerically, the biogenic carbon content can be expressed as the amount of biogenic carbon in the material as a weight percent of the total carbon (TC) in the material (in accordance with ASTM D6866 (2020) or EN 16640 (2017)). In the present context, the term renewable preferably refers to a material having a biogenic carbon content of more than 50 wt-%, especially more than 60 wt-% or more than 70 wt-%, preferably more than 80 wt-%, more preferably more than 90 wt-% or more than 95 wt-%, even more preferably about 100 wt-%, based on the total weight of carbon in the material (EN 16640 (2017)).

According to a first aspect, herein is provided a hydrocarbon component, preferably a renewable diesel fuel component, comprising n-paraffins, mono-branched i-paraffins, and multiple-branched i-paraffins, wherein the sum amount of C15-C22 n-paraffins, C15-C22 mono-branched i-paraffins, and C15-C22 multiple-branched i-paraffins is at least 90 wt-%, or within a range from 90 to 99 wt-%, of the total hydrocarbon component weight, and wherein the weight ratio of C15-C22 i-paraffins to C15-C22 n-paraffins is at least 22:1, preferably at least 24:1, more preferably at least 30:1, even more preferably at least 34:1. High paraffin content gives excellent cetane number to the hydrocarbon component. In addition, high carbon number paraffins ensure higher density compared to traditional hydrotreated vegetable oil and fuel components derived therefrom. Higher density gives a possibility to blend higher volumes of the hydrocarbon component into fossil diesel without undercutting the density requirement of the blend.

The present inventors have found the present hydrocarbon component comprising high content of paraffins within carbon number range C15-C22 highly beneficial for several reasons. For example, high paraffin content leaves little room for aromatics, olefins and naphthenes, and reducing or minimising their contents may support meeting standards, such as EN 15940. High paraffins content may also provide ready biodegradability. Further, the present highly paraffinic hydrocarbon components may provide better performance regarding burning and/or emissions to the end user. Further, the blendability of the present hydrocarbon component, being highly isoparaffinic, to other typical diesel fuel range components is very good. Further, the present highly paraffinic hydrocarbon component is more stable or more inert e.g. during storage and in blends, compared to components with higher content of non-paraffins, particularly of olefins, that might react and form high molecular weight precipitates, i.e. gums in the component or in blend composition thereof. Also, aromatics can be susceptible to instability, particularly with increasing aromatic size and concentration, resulting in a higher deposition propensity upon stressing e.g. caused by oxidation and molecular growth of the aromatics. Improved stability is particularly desired property e.g. for apparatuses used only seasonally, or hybrid vehicles using another primary power source, such as electricity or gas, and diesel only as a secondary fuel which is retained in the fuel system for longer periods. Additionally, a range of paraffins, such as a range within C15-C22, is more beneficial for end product properties when blended with other typical diesel fuel range components than a neat or pure component, such as neat C16 paraffin. Typically, the carbon number distribution of the paraffins in the present hydrocarbon component covers at least four adjacent carbon numbers, preferably at least five adjacent carbon numbers, more preferably at least six adjacent carbon numbers, within the range from C15 to C22. Preferably, the present hydrocarbon component comprises hydrocarbons of three different carbon numbers within the C15-C22 range at least 5 wt-% per carbon number.

Hence, according to certain preferred embodiments, in the present hydrocarbon component the sum amount of C15-C22 n-paraffins, C15-C22 mono-branched i-paraffins, and C15-C22 multiple-branched i-paraffins is at least 92 wt-%, preferably at least 95 wt-%, more preferably from 95 to 99 wt-%, of the total hydrocarbon component weight.

In the hydrocarbon component, the weight ratio of C15-C22 i-paraffins to C15-C22 n-paraffins is at least 22:1, preferably at least 24:1, more preferably at least 30:1, even more preferably at least 34:1. The isomerization degree may set an upper limit for feasible ratio. Said ratio may be from 24:1 to 1000:1, preferably from 34:1 to 1000:1. Experimentally, results showed a wide variety of high values for weight ratio of C15-C22 i-paraffins to C15-C22 n-paraffins, typically from about 22:1 to about 100:1, such as from about 24:1 to about 100:1. Very high ratios may be reached when the amount of n-paraffins approaches zero. In practice, some n-paraffins are typically present. High sum amount of C15-C22 range paraffins together with the very high weight ratio of C15-C22 i-paraffins to C15-C22 n-paraffins provides the very desired combination of excellent cold properties, particularly viscosity at subzero temperature, elevated density, and elevated viscosity at 40° C. to the component, and at the same time high cetane number and good cold start properties.

The high C15-C22 paraffin content evidently leaves little room for the presence of other component in the total hydrocarbon component composition. Hence, in certain preferred embodiments the sum amount of any C1-C14 hydrocarbons is at most 3 wt-% or at most 2 wt-%, or from 0.1 to 3 wt-% of the total hydrocarbon component weight. This ensures an elevated flash point to the hydrocarbon component. The carbon number distribution contributes to the density of the hydrocarbon component. Further, high content of C15-C22 paraffins increases the viscosity at temperatures above zero.

The present hydrocarbon component is highly paraffinic and the majority of said paraffins are isomerized. Accordingly, in certain preferred embodiments, the sum amount of total n-paraffins is at most 5 wt-%, preferably at most 3 wt-% of the total hydrocarbon component weight. High relative proportion of i-paraffins to n-paraffins as such is associated with good cold properties, which can be further improved by raising the isomerization degree. Dissolved waxes can also increase pour point, which can be undesired or even detrimental in many applications. The very low total content of n-paraffins further reduces risk of solidification thereof e.g. on cold surfaces.

Preferably, the present hydrocarbon component has a sum amount of C15-C22 i-paraffins at least 80 wt-%, preferably at least 85 wt-%, more preferably at least 90 wt-%, even more preferably at least 95 wt-% of the total hydrocarbon component weight. Such embodiments may be regarded typical.

A significant share of the i-paraffins may contain more than one branch, herein referred to as multiple-branched i-paraffins. Preferably, the content or share of C15-C22 multiple-branched i-paraffins is high when compared to the amount of mono-branched i-paraffins, to total amount of paraffins, or to the amount of n-paraffins in the hydrocarbon component, contributing to the enhanced cold properties, including fluidity at subzero temperatures.

This may be expressed by the content of C15-C22 mono-and multiple-branched i-paraffins, particularly by reduced content of mono-and elevated content of multiple-branched i-paraffins. Hence, according to certain embodiments, the hydrocarbon component has a sum amount of C15-C22 mono-branched i-paraffins at most 35 wt-%, preferably at most 30 wt-%, more preferably at most 25 wt-% of the total hydrocarbon component weight. According to certain further embodiments, the hydrocarbon component has a sum amount of C15-C22 multiple-branched i-paraffins at least 60 wt-%, preferably at least 63 wt-%, more preferably at least 65 wt-% of the total hydrocarbon component weight.

A further way of expressing this is by the weight ratio of C15-C22 multiple-branched i-paraffins to C15-C22 mono-branched i-paraffins, which may be at least 1.8, preferably at least 2.0, more preferably at least 2.5. Said ratio may be even far higher, such as about 20, as shown by the Examples. According to certain embodiments, the weight ratio of C15-C22 multiple-branched i-paraffins to C15-C22 mono-branched i-paraffins may be from 1.8 to 40, such as from 2.0 to 25, or from 2.0 to 20. Surprisingly, the inventors found that the high content of multiple-branched i-paraffins, or the high multiple-branched i-paraffins/mono-branched i-paraffins ratio, provided excellent cold properties to the hydrocarbon components, particularly far lower cloud points than expected based on the weight ratio of C15-C22 i-paraffins to C15-C22 n-paraffins alone.

The high i-paraffin content, and especially a high content of multiple branched i-paraffins, allows incorporating in the present hydrocarbon component a high share of heavier paraffins in the C15-C20 range contributing for example to elevated density allowing to incorporate the present hydrocarbon component for example to diesel fuels, especially winter or arctic grade diesel fuels, in high amounts while having a density within specification of the diesel fuel. Accordingly, in certain preferred embodiments, the hydrocarbon component comprises C18 i-paraffins at least 35 wt-%, preferably at least 40 wt-%, further preferably at least 45 wt-%, more preferably at least 50 wt-%, even more preferably at least 55 wt-%, most preferably at least 60 wt-%, typically at most 80 wt-% or at most 78 wt-% or at most 76 wt-%, such as from 48 wt-% to 80 wt-% or from 48 wt-% to 75 wt-%, based on the total hydrocarbon component weight. In certain preferred embodiments, a sum amount of C19-C22 i-paraffins in the hydrocarbon component is at least 6 wt-% or at least 8 wt-%, preferably at least 9 wt-%, more preferably at least 10 wt-%, typically at most 55 wt-%, or at most 50 wt-%, or at most 45 wt-%, such as at most 40 wt-%, based on the total hydrocarbon component weight. In certain particularly preferred embodiments, a sum amount of C19-C22 multiple-branched i-paraffins in the hydrocarbon component is at least 5 wt-% or at least 6 wt-%, preferably at least 7 wt-%, more preferably at least 8 wt-%, typically at most 50 wt-%, or at most 45 wt-%, or at most 40 wt-%, such as at most 35 wt-%, based on the total hydrocarbon component weight. Such C19-C22 i-paraffin and/or C19-C22 multiple-branched i-paraffin contents may be comprised in hydrocarbon components having C18 i-paraffin content as defined above. C19-C22 i-paraffin, C19-C22 multiple-branched i-paraffin, and/or C18 i-paraffin contents as defined above are beneficially comprised especially in hydrocarbon components having C15-C22 i-parraffin contents and/or C15-C22 i-paraffins to C15-C22 n-paraffins ratios, and/or C15-C22 multiple-branched i-paraffin contents and/or C15-C22 multiple-branched i-paraffins to C15-C22 mono-branched i-paraffins ratios as defined in the foregoing.

The component of interest here may be defined as renewable hydrocarbon component, because at least a part of the raw material from which the component is derived is preferably of non-fossil origin. The biogenic carbon content may be defined for any feasible composition according to EN 16640 (2017). In certain embodiments, the hydrocarbon component has a biogenic carbon content of at least 50 wt-%, preferably at least 70 wt-%, more preferably at least 90 wt-%, or even about 100 wt-%, based on the total weight of carbon (TC) in the hydrocarbon component. Such hydrocarbon components may help to increase the bio-content of products where it is used. Hydrocarbon components with biogenic carbon content are also desired for many uses due to their extremely low sulphur content.

The hydrocarbon component may have a kinematic viscosity at 40° C. of more than 3.0 mm²/s, preferably more than 3.9 mm²/s, more preferably at least 4.0 mm²/s. As an upper limit given for the kinematic viscosity at 40° C. of the hydrocarbon component less than 7.0 mm²/s, less than 6.0 mm²/s, less than 5.0 mm²/s or less than 4.5 mm²/s may be reasoned based on the experiments conducted, and based on the desired properties in various uses. Hence, in certain preferred embodiments the hydrocarbon component has a kinematic viscosity at 40° C. from more than 3.0 to 7.0 mm²/s, from more than 3.9 to 7.0 mm²/s, or from more than 3.9 to 6.0 mm²/s, as determined according to EN ISO 3104-2020. The kinematic viscosities for conventional fossil arctic grade diesels are typically low, such as below 2.000 mm²/s. The present hydrocarbon component may be used to improve or optimize properties of diesel fuel, particularly of arctic grades, such as viscosity, cetane number, and cold properties, even all said properties at the same time. For example, the present hydrocarbon component could be used to improve the viscosity at 40° C. of arctic grade diesel thereby improving its behavior in the fuel system. Higher viscosity improves the spraying of the fuel in the fuel system, that leads to better fuel economy. For diesel fuels, the kinematic viscosity preferably meets EN590:2022/EN15940:2019 specification limit (viscosity at 40° C. max. 4.500 mm²/s).

The kinematic viscosity at subzero temperatures is lower than expected based on the carbon number distribution of the present hydrocarbon component. This is beneficial when optimizing properties of blend products, such as diesel fuel, particularly when the present hydrocarbon component is used in arctic grade diesel blends. Typically, the kinematic viscosity of the present hydrocarbon component at −20° C. may be within a range from 20 to 100 mm²/s, preferably from 30 to 50 mm²/s, more preferably from 30 to 45 mm²/s as determined according to EN ISO 3104-2020. When studying the kinematic viscosity of the present hydrocarbon component at even lower temperatures, it was found that typically said component may have kinematic viscosity at −40° C. within a range from 160 to 200 mm²/s, or from 160 to 185 mm²/s, thus easily meeting even stringent subzero temperature performance requirements, such as the maximum specification for kinematic viscosity at −40° C. of low temperature switchgear oils, which is 400 mm²/s (IEC 60296-2012).

The elevated density of the present hydrocarbon component is beneficial providing higher calorific value compared to traditional hydrotreated vegetable oil derived components. As a result, fuel consumption is a bit lower. The density has also influence on the component blending, enabling to blend more of the hydrocarbon component into fossil fuel before reaching the lower limit of a density specification. Typically, the density at 15° C. of the hydrocarbon component is at least 780 kg/m³, preferably at least 785 kg/m³, more preferably at least 790 kg/m³, such as within a range from 780 to 800 kg/m³, preferably from 785 to 800 kg/m³, more preferably from 790 to 795 kg/m³ as determined according to EN ISO 12185-1996.

In certain embodiments, the flash point of the hydrocarbon component is 100° C. or higher, preferably 110° C. or higher, more preferably 135° C. or higher, such as up to 160° C., e.g. within a range from 110° C. to 150° C., as determined according to ISO 2719-2016 (Pensky-Martens closed cup procedure). Such flash points are beneficial in certain uses or applications. For example, for low temperature switch gear oils the flash point should not be below 100° C.

The hydrocarbon component was found to have a very low cloud point. Experimentally, low cloud point values less than −30° C., such as −35° C., −38° C., −41° C., −42° C., −43° C., −44° C., −64° C. were measured for the present hydrocarbon component. Typically, the cloud point of the hydrocarbon component may be −32° C. or lower, preferably −35° C. or lower or more preferably −40° C. or lower. When expressed as temperature ranges, the cloud point of the hydrocarbon component may typically vary within a range from −32° C. to −70° C., preferably from −35 to −70° C., such as from −40 to −70° C. Cloud point is preferably determined according to ASTM D 5771-17. In the case of renewable diesel, the cloud point and cold filter plugging point (CFPP) are practically the same. Therefore, the lowest storage temperature of the fuel (cloud point) typically reflects also the lowest operating temperature (CFPP).

Owing to the advantageous physico-chemical characteristics described, the present hydrocarbon component suits especially well for use as a diesel fuel component and any characterization or embodiments of the present hydrocarbon component applies to a renewable diesel fuel component described herein. Hence, according to certain preferred embodiments, the present hydrocarbon component is a renewable diesel fuel component. Due to the outstanding characteristics at very low temperatures, such as at −28° C., −34° C., −38° C., even at −44° C., preferably the present hydrocarbon component is a renewable arctic grade diesel fuel component. Examples of arctic grade diesels are those of Class 3 and Class 4 according to EN590:2022.

Cetane number describes the ignition delay of a diesel fuel, higher cetane values denoting shorter ignition delay and thus easier ignition, i.e. better ignition quality of a diesel fuel. Typically, the present renewable diesel fuel component may have a cetane number of at least 51, preferably at least 65, more preferably at least 68, even more preferably at least 70, most preferably at least 74, as determined according to EN 15195-2014. Typically, the cetane numbers of the renewable diesel fuel components may be within a range from 51 to 84, such as from 68 to 80.

Elevated moisture or water content may also be highly undesirable as it adversely affects e.g. dielectric properties, important particularly for use in transformer oils. Typically, the present hydrocarbon component may have a water content of at most 100 w-ppm, preferably at most 50 w-ppm, more preferably at most 40 w-ppm, or at most 30 w-ppm, as determined according to IEC 60814.

The beneficial characteristics, especially the elevated i-paraffin/n-paraffin ratio in C15-C22 paraffins of the present hydrocarbon component may be contributed by the production process and a feed thereto. Additives or enhancers for improving cold properties or cetane number may not be necessary. The hydrocarbon component may be directly obtainable or obtained from product recovery of the production process.

In certain embodiments, the hydrocarbon component is obtainable or obtained by a process comprising providing a paraffinic hydrocarbon feed, preferably obtained by hydrodeoxygenation of an oxygenated hydrocarbon feed typically comprising vegetable oils, animal fats, and/or microbial oils and optionally followed by gas-liquid separation and/or paraffinic feed fractionation(s), and subjecting the paraffinic hydrocarbon feed to at least hydroisomerisation, preferably to hydroisomerisation and hydrocracking, followed by fractionation, and recovering from the fractionation at least the hydrocarbon component. The feed(s) and process steps, especially the paraffinic hydrocarbon feed, the hydroisomerisation and the optional hydrocracking, and the fractionation, are preferably as further defined herein.

Hence, according to certain embodiments, the present hydrocarbon component is obtainable by a process comprising
providing a paraffinic hydrocarbon feed comprising at least 60 wt-% paraffins of the total weight of the paraffinic hydrocarbon feed, of which paraffins at most 30 wt-% are i-paraffins;
subjecting the paraffinic hydrocarbon feed in a first reaction section, preferably in a first reactor, to hydroisomerisation in the presence of a hydroisomerisation catalyst to obtain a hydroisomerisation effluent;
subjecting a second reaction section feed comprising at least a portion of the hydroisomerisation effluent to hydrocracking in a second reaction section, preferably in a second reactor, in the presence of a hydrocracking catalyst to obtain a hydrocracking effluent;
subjecting the hydrocracking effluent, and optionally (at least) a portion of the hydroisomerisation effluent, to fractionation, and recovering from the fractionation at least the hydrocarbon component, and optionally an aviation fuel component.

In addition to the hydrocarbon component and optionally recovered aviation fuel component, at least a gasoline fuel component and/or a marine fuel component may be recovered from the fractionation. Optionally, also other products may be recovered.

Preferably, the process further comprises recovering from the fractionation a recycle stream, preferably having a T5 temperature (5 vol-% recovered, EN ISO 3405-2019) of 270° C. or higher and optionally comprising C16 n-paraffins. The recycle stream may be comprised in the at least a portion of the hydroisomerisation effluent or form the at least a portion of the hydroisomerisation effluent subjected to hydrocracking in the second reaction section, preferably second reactor. In other words, the recycle stream is subjected, as part of the second reaction section feed to hydrocracking in the second reaction section, preferably in the second reactor. The recycle stream may comprise at least a portion of the fractionation bottom. In embodiments where a recycle stream is separated, the yield of desired liquid fuel component(s) can be further optimised, particularly in embodiments where the second reaction section feed fed to hydrocracking comprises in addition to the recycle stream a further portion of the hydroisomerisation effluent. In embodiments where a recycle stream is separated, the hydrocarbon component is preferably recovered by separating a portion from the recycle stream (or in other words, the recycle stream is separated as a portion from the hydrocarbon component). Hence, the hydrocarbon component may have a T5 temperature (5 vol-% recovered, EN ISO 3405-2019) of 270° C. or higher.

In the present process, the paraffinic hydrocarbon feed comprises at least 60 wt-%, preferably at least 70 wt-%, more preferably at least 80 wt-%, even more preferably at least 90 wt-% paraffins of the total weight of the paraffinic hydrocarbon feed. The paraffinic hydrocarbon feed of the present disclosure may comprise even at least 95 wt-% paraffins of the total weight of the paraffinic hydrocarbon feed or consist essentially of paraffins. The paraffinic hydrocarbon feed of the present disclosure may contain minor amounts of olefins, preferably less than 5 wt-%, more preferably less than 1 wt-%, based on the total weight of the paraffinic hydrocarbon feed, as well as minor amounts of aromatics and/or naphthenes.

An advantage of using a highly paraffinic hydrocarbon feed in the process of the present disclosure is that paraffins isomerise relatively easily and at milder conditions when subjected to hydroisomerisation compared to e.g. cyclic hydrocarbons. Also, paraffins crack relatively easily and at milder conditions when subjected to hydrocracking, which helps to reduce formation of light gases.

In the present process, the paraffinic hydrocarbon feed comprising at least 60 wt-% paraffins of the total weight of the paraffinic hydrocarbon feed, of which paraffins at most 30 wt-% are i-paraffins, may be obtained from a paraffinic hydrotreatment effluent, such as a hydrodeoxygenation (HDO) effluent, a paraffinic Fischer-Tropsch (FT) effluent, or a combination thereof, after having subjected said effluent(s) at least to gas-liquid separation, i.e. removal of at least compounds that are gaseous at NTP, and optionally also to paraffinic feed fractionation(s). While e.g. paraffinic FT effluents of fossil origin are readily available (in addition to FT effluents of renewable origin), the paraffinic hydrocarbon feed of the present disclosure is at least partially renewable, i.e. comprises biogenic components.

Preferably, the paraffinic hydrocarbon feed of the present disclosure comprises or consists essentially of a hydrodeoxygenation (HDO) effluent, or a fraction thereof, such as a degassed hydrodeoxygenation effluent or a fraction thereof, from catalytic hydrodeoxygenation (catalytic HDO) of an oxygenated hydrocarbon feed. Preferably, the oxygenated hydrocarbon feed comprises at least one or more of vegetable oil, animal fat and/or microbial oil. This kind of paraffinic hydrocarbon feeds tend to have relatively narrow carbon number distribution and therefore benefit more from being subjected to the present process, compared e.g. to FT-based feeds usually having substantially Gaussian distribution of hydrocarbon chains and a wide carbon chain length distribution. Typically, providing the paraffinic hydrocarbon feed comprises subjecting an oxygenated hydrocarbon feed to hydrodeoxygenation in the presence of a hydrodeoxygenation catalyst to obtain a hydrodeoxygenation effluent, and then subjecting the hydrodeoxygenation effluent to gas-liquid separation, and optional paraffinic feed fractionation to obtain as the paraffinic hydrocarbon feed the degassed hydrodeoxygenation effluent or a fraction thereof. Hydrodeoxygenation may be conducted as described in prior art publications, such as FI100248B, EP1741768A1, EP2155838B1, or FI129220 B1.

Generally, in the context of the present disclosure, hydroisomerisation (HI) of the paraffinic hydrocarbon feed in the first reaction section/reactor is operated so that isomerisation reactions prevail while cracking reactions are controlled or suppressed. Typically, the HI in the first reaction section/reactor is conducted at a temperature within a range from 200° C. to 500° C., preferably from 230° C. to 500° C., more preferably from 250° C. to 450° C., even more preferably from 280° C. to 400° C., a pressure within a range from 1 MPa to 10 MPa, preferably from 2 MPa to 8 MPa, or from 3 MPa to 10 MPa, a H₂ partial pressure at the inlet of the first reaction section/reactor within a range from 1 MPa to 10 MPa, preferably from 2 to 8 MPa, a weight hourly space velocity within a range from 0.1 to 10, preferably from 0.2 to 8, more preferably from 0.4 to 6 kg paraffinic hydrocarbon feed per kg catalyst per hour, and a H₂ to paraffinic hydrocarbon feed ratio within a range from 10 to 2000, preferably from 50 to 1000 normal liters H₂ per liter paraffinic hydrocarbon feed. Hydroisomerisation may be conducted as described in prior art publications, such as FI100248B, EP1741768A1, EP2155838B1, or FI129220 B1. Severity of the HI may be increased by at least one or more of: decreasing WHSV, increasing temperature, and/or increasing pressure. When using fresh HI catalyst, high severity HI conditions may be reached at lower temperature, and/or pressure, and/or using higher WHSV, and towards the end of the HI catalyst lifetime higher temperature, and/or pressure, and/or lower WHSV may be needed to reach even medium severity HI. In the present context, HI that yields liquid effluents having, as wt-% of paraffins in the liquid effluent, total i-paraffins content 50-85 wt-% and multiple-branched i-paraffins content at most 25 wt-%, or total i-paraffins content 85-95 wt-% and multiple-branched i-paraffins content 25-55 wt-%, or total i-paraffins content at least 95 wt-% and multiple-branched i-paraffins content more than 55 wt-%, is generally regarded as HI of low severity, or medium severity, or high severity, respectively, although these content ranges are merely for illustrating the order of magnitude, and may overlap to some extent, and vary from case to case.

Generally, hydrocracking in the second reaction section/reactor is operated so that cracking reactions, especially those enhancing degree of effective cracking, particularly to C8-C14 hydrocarbons but also to lighter non-gaseous hydrocarbons, are more abundant than in the hydroisomerisation in the first reaction section/reactor. Preferably, cracking reactions, especially those enhancing the degree of effective cracking, prevail in the hydrocracking in the second reaction section/reactor, yet generally without excessive cracking and excessive fuel gas formation. Typically, the hydrocracking in the second reaction section/reactor is conducted at a temperature within a range from 200° C. to 450° C., preferably from 220° C. to 430° C., more preferably from 280° C. to 350° C., a pressure within a range from 0.4 MPa to 8 MPa, preferably from 1 MPa to 7 MPa, a H₂ partial pressure at the inlet of the second reaction section/reactor within a range from 0.4 MPa to 8 MPa, preferably from 1 MPa to 7 MPa, a weight hourly space velocity within a range from 0.1 to 10, preferably from 0.2 to 8, more preferably from 0.4 to 6, even more preferably from 0.5 to 1.5 kg second reactor feed per kg catalyst per hour, and a H₂ to second reactor feed ratio within a range from 10 to 2000, preferably from 50 to 1000 normal liters H₂ per liter second reactor feed.

Preferably, the hydroisomerisation catalyst is a non-sulphided bifunctional hydroisomerisation catalyst and the hydrocracking catalyst is a non-sulphided bifunctional hydrocracking catalyst, preferably said non-sulphided bifunctional catalysts comprising at least one or more metal(s) selected from noble metals of Group VIII, more preferably at least one or more metal(s) selected from Pt and/or Pd, and at least one or more acidic porous material(s). Non-sulphided bifunctional catalysts are preferred because they do not require sulphidation during operation for maintaining their activity, and hence the sulphur content of various process streams and products may be kept low, and less efficient H₂S separation and recovery is needed. Especially non-sulphided bifunctional catalysts comprising noble-metals may be active at lower temperatures and show higher selectivity for isomerisation reactions, compared to sulphided catalysts, but are sensitive to deactivation by H₂S. Particularly for the hydrocracking reactions in the second reaction section/reactor, bifunctional hydrocracking (HC) catalysts are beneficial because they have in addition to cracking activity also at least some isomerisation activity, and may be particularly efficient in effective cracking. As further advantage, bifunctional hydrocracking catalysts comprising at least one or more metals selected from Group VIII noble metals, preferably Pt and/or Pd, have been found to provide at relatively low temperatures a high activity compared to HC catalysts comprising non-noble metals, and thus better control of thermal cracking. At low temperatures, the thermodynamic equilibrium tends to shift towards dearomatisation, thus reducing aromatics formation by side reactions. Providing the second reaction section/reactor with a bifunctional HC catalyst may also achieve an isoparaffin content (wt-% isoparaffins of the total weight paraffins) in the hydrocracking effluent that is not necessarily significantly lower than in the hydroisomerisation effluent, or may be the same or even higher.

According to certain preferred embodiments, the present hydrocarbon component is obtainable by a process comprising
subjecting an oxygenated hydrocarbon feed comprising at least one or more of vegetable oil, animal fat and/or microbial oil to hydrodeoxygenation, followed by gas-liquid separation, to provide a paraffinic hydrocarbon feed comprising at least 60 wt-% paraffins of the total weight of the paraffinic hydrocarbon feed, of which paraffins at most 30 wt-% are i-paraffins;
subjecting the paraffinic hydrocarbon feed in a first reaction section, preferably in a first reactor, to hydroisomerisation in the presence of a hydroisomerisation catalyst to obtain a hydroisomerisation effluent;
subjecting a second reaction section feed comprising at least a portion of the hydroisomerisation effluent, optionally comprising a recycle stream, to hydrocracking in a second reaction section, preferably in a second reactor, in the presence of a hydrocracking catalyst to obtain a hydrocracking effluent;
subjecting the hydrocracking effluent to fractionation, and recovering from the fractionation at least the hydrocarbon component, and optionally an aviation fuel component, and optionally separating the recycle stream, preferably having a T5 temperature (5 vol-% recovered, EN ISO 3405-2019) of 270° C. or higher, as a portion from the hydrocarbon component.

The prevailing component in the paraffinic hydrocarbon feed is n-paraffins. However, the presence of a certain amount of i-paraffins in the paraffinic hydrocarbon feed may still be beneficial. Compared to otherwise similar feeds but without i-paraffin content, paraffinic hydrocarbon feeds containing a certain amount of i-paraffins may achieve a hydroisomerisation effluent with a higher content of multiple-branched i-paraffins.

Preferably, the paraffinic hydrocarbon feed of the present disclosure comprises at least 70 wt-%, preferably at least 80 wt-%, more preferably at least 90 wt-% hydrocarbons having a carbon number within a range from C12 to C30, even more preferably within a range from C14 to C22, of the total weight of the paraffinic hydrocarbon feed. These feeds allow good yields of two or more fuel components of different kinds, and are readily available for example from conventional hydrodeoxygenation processes of vegetable oils, animal fats and/or microbial oils, comprising fatty acids. Paraffinic feeds on the heavier side are obtainable e.g. from HDO of oil from energy crops such as Brassica species, algal oils, crude tall oil (CTO), tall oil fatty acids (TOFA), and/or tall oil pitch (TOP).

Presence of multiple-branched i-paraffins in the hydroisomerisation effluent may be considered beneficial as it may contribute beneficially to the degree of effective cracking in the hydrocracking step. When a desired degree of effective cracking, particularly to C8-C14 hydrocarbons but also to lighter non-gaseous hydrocarbons, is achieved in the hydrocracking step at milder operating conditions, excessive cracking may be avoided, and formation of gaseous hydrocarbons reduced. Also, an increased content of multiple-branched i-paraffins in the hydroisomerisation effluent may be considered beneficial in that it may provide improved cold properties to the hydrocarbon component as well as to the optionally recovered aviation fuel component, and/or improved RON to the optionally recovered gasoline fuel component. Without being bound to any theory, it is believed that a multiple-branched i-paraffin is more likely to form two branched paraffin molecules upon cracking in the hydrocracking step instead of one branched and one n-paraffin, hence increasing the i-paraffin content of the hydrocracking effluent relative to n-paraffin content. The same can be seen also downstream in the products recovered from fractionation, and in an optionally recovered recycle stream.

According to certain embodiments, the first reaction section for hydroisomerisation and the second reaction section for hydrocracking may be situated in one and the same reactor, e.g in separate catalyst beds with appropriate equipment thereto. According to certain other embodiments, the first reaction section for hydroisomerisation is in a first reactor and the second reaction section for hydrocracking is in a second reactor. Having the hydroisomerisation section in a first reactor and the hydrocracking section in a second reactor provides advantages i.e. in process design, process controls, and maintenance.

Preferably, the at least a portion of the hydroisomerisation effluent subjected to hydrocracking comprises at least 50 wt-%, further preferably at least 60 wt-%, more preferably at least 70 wt-%, even more preferably at least 80 wt-% isoparaffins of the total amount of paraffins in the at least a portion of the hydroisomerisation effluent, and optionally multiple-branched isoparaffins at least 5 wt-%, preferably at least 10 wt-%, more preferably at least 15 wt-%, even more preferably at least 20 wt-%, and typically at most 70 wt-%, of the total amount of paraffins in the at least a portion of the hydroisomerisation effluent. Typically, the at least a portion of the hydroisomerisation effluent has a cloud point less than 0° C., preferably less than −5° C., more preferably less than −8° C., even more preferably less than −10° C., or less than −15° C. (ASTM D 5771-17).

Hydrocracking of at least a portion of the hydroisomerisation effluent increases the yield of non-gaseous cracking products, particularly C8-C14 but also lighter non-gaseous hydrocarbons, contributing to yield(s) of component(s) in gasoline and/or aviation fuel range. As the feed to the hydrocracking may contain elevated i-paraffins content, and elevated multiple-branched i-paraffins content, the present inventors have found that with the hydrocracking it is possible to yield further i-paraffins instead of decreasing their amount, without excessive cracking to less valuable light C1-C3 hydrocarbons.

The advantageous hydrocarbon composition of the present hydrocarbon component, specifically in relation to the relatively narrow carbon number distribution mainly in the C15-C22 range, very high content of i-paraffins, and preferably of multiple-branched i-paraffins, and very low content of n-paraffins, is demonstrated to enhance also its physico-chemical characteristics, for example those desired for use in diesel fuel compositions, particularly for use in arctic diesel fuels. When studied in laboratory conditions, characteristics correlating with properties desired for fuels are e.g. the shape of the distillation curve and distillation characteristics.

According to certain embodiments, here is provided a hydrocarbon component, wherein the difference between T95 temperature (95 vol-% recovered, EN ISO 3405-2019) and T5 temperature (5 vol-% recovered, EN ISO 3405-2019) is at most 70° C., preferably at most 65° C., more preferably at most 60° C., typically at least 10° C., preferably at least 15° C., more preferably at least 25° C., typically within a range from 10° C. to 70° C., preferably from 15° C. to 70° C., more preferably from 20° C. to 70° C., even more preferably from 25° C. to 65° C. While the relatively narrow boiling range may provide certain benefits, defining a lowest boiling range as exemplified here may be beneficial as well, for example for burning and blending properties. Preferably, the hydrocarbon component has a T5 temperature (5 vol-% recovered, EN ISO 3405-2019) of 270° C. or higher, preferably 275° C. or higher, more preferably 280° C. or higher, typically between 270° C. and 310° C. or within a range from 270° C. to 310° C., so as to increase the C15-C22 range paraffin content, density and flash point, and to allow recovery of an aviation fuel component in high yield from the same production process. Typically, the hydrocarbon component may have a final boiling point (FBP) at most 380° C., preferably at most 370° C., more preferably at most 360° C., even more preferably at most 350° C., as determined according to EN ISO 3405-2019. Such FBPs are generally considered to be within diesel fuel boiling range. The present hydrocarbon component enables inclusion of heavier i-paraffins within the C15-C22 range, especially as defined in the foregoing, while still boiling within diesel range. According to a second aspect, a diesel fuel composition according to the present disclosure comprises a hydrocarbon component or a diesel fuel component, preferably a renewable hydrocarbon component or renewable diesel component, as defined earlier, in an amount from 1 to 99 vol-%, preferably from 10 to 70 vol-%, such as in an amount of at least 10 vol-%, at least 15 vol-%, at least 20 vol-%, at least 25 vol-%, at least 30 vol-%, at least 35 vol-%, at least 40 vol-%, at least 45 vol-%, at least 50 vol-%, at least 55 vol-%, at least 60 vol-%, or at least 65 vol-% of the total diesel fuel composition volume. Surprisingly, high volume share, such as 70 vol-%, of the hydrocarbon component in the diesel fuel composition is possible in particular due to the exceptionally high density compared to conventional paraffinic diesel components.

The rest of the diesel fuel composition may consist of diesel fuel components, and optionally additives, especially those typical for the prior art. Most common diesel fuel components are currently fossil diesel grades. For embodiments, where low storage or operating temperatures are involved, the diesel fuel components (in addition to the present component) may be selected from winter diesel grades of Class 0 or winter diesel grades of Class 1 or winter diesel grades of Class 2 or arctic diesel grades of Class 3 or arctic diesel grades of Class 4, according to EN590:2022. An exemplary diesel fuel composition may comprise e.g. the present hydrocarbon component, a fossil arctic diesel grade hydrocarbon component, and an antioxidant. In certain embodiments, the diesel fuel composition fulfills the requirements for diesel fuels set in Directive 2009/30/EC. In certain embodiments, also the requirements of EN590:2022 are met.

The blending of the present hydrocarbon component with arctic grade fossil diesel was studied experimentally and reported in the present examples comparing to prior art renewable diesel component. Advantages were shown for example in relation to the kinematic viscosity, calorific values, and the cold properties of the blend. The results were improved along with increasing proportion of the present hydrocarbon component in the blend.

Hence, according to a third aspect, a hydrocarbon component according to the present disclosure may be used in a diesel fuel composition for improving one or more product properties of the diesel fuel composition. Said one or more product properties of the diesel fuel composition comprises at least one or more of kinematic viscosity at 40° C., cloud point, cold filter plugging point, cetane number, density, calorific value, and/or biogenic carbon content.

In certain embodiments, there is provided the use of the present hydrocarbon component to provide a diesel fuel composition fulfilling the requirements for diesel fuels set in Directive 2009/30/EC. In certain embodiments, also the requirements of EN590:2022 are met.

In certain embodiments, the hydrocarbon component may be used in a diesel fuel composition in amount from 1 vol-% to 99 vol-%, preferably from 10 vol-% to 70 vol-%, such as of 10 vol-%, 15 vol-%, 20 vol-%, 25 vol-%, 30 vol-%, 35, vol-%, 40 vol-%, 45 vol-%, 50 vol-%, 55 vol-%, 60 vol-%, or 65 vol-% of the total diesel fuel composition volume. Such use typically improves at least the biogenic carbon content of the diesel fuel composition.

Due to its improved properties the present hydrocarbon component is usable in a wide range of applications, particularly in arctic grade diesel fuels, wherein it can be incorporated in high proportions.

In addition to the usability in diesel fuel compositions, the present hydrocarbon component is suitable for a wide range of various other uses, such as in feedstock(s) for industrial conversion process(es), preferably in thermal cracking feedstock(s), such as in steam cracking feedstock(s), and/or in catalytic cracking feedstock(s), in transformer oil(s), in heat-transfer medium or media, in switchgear oil(s), in shock absorber oil(s), in insulating oil(s), in hydraulic fluid(s), in gear oil(s), in transmission fluid(s), in degreasing composition(s), in penetrating oil(s), in anticorrosion composition(s), in multipurpose oil(s), in metal working fluid(s), in rolling oil(s) especially for aluminium, in cutting oil(s), in drilling fluid(s), in solvent(s), in lubricant(s), in extender oil(s), in carrier(s), in dispersant composition(s), in demulsifier(s), in extractant(s), in paint composition(s), in coating fluid(s) or paste(s), in adhesive(s), in resin(s), in varnish(es), in printing paste(s) or ink(s), in detergent(s), in cleaner(s), in plasticizing oil(s), in turbine oil(s), in hydrophobization composition(s), in agriculture, in crop protection fluid(s), in construction, in concrete demoulding formulation(s), in electronics, in medical appliance(s), in composition(s) for car, electrical, textile, packaging, paper, cosmetic and/or pharmaceutical industry, and/or in manufacture of intermediate(s) therefor. The elevated isoparaffin to n-paraffin ratio of the present hydrocarbon components may improve fluidity, pumping and mixing characteristics, and blendability, that are generally desired and beneficial properties for a wide range of uses, and particularly for uses involving spraying, injecting, and/or admixing with other ingredients. Use of the present hydrocarbon component is particularly preferred in transformer oil(s), but also in thermal cracking feedstock(s) and/or in catalytic cracking feedstock(s) for producing olefinic monomers, particularly ethylene and/or propylene, as the very low cyclics' content helps to reduce formation of coke-forming aromatics, very high paraffin content helps to improve conversion to light olefins, even at less severe cracking conditions, and the high isoparaffin content is foreseen to favor generation of favorable propylene to ethylene product ratios in these processes.

Depending on the intended use, the hydrocarbon component or the diesel fuel composition may be suitably additized, for example with at least one or more of antioxidant(s), stabilizer(s), detergent(s), corrosion inhibitor(s), friction modifier(s), metal deactivator(s), lubricating additive(s), antifoaming agent(s), and/or fuel dye(s), just to name a few.

### Schematic Presentation of the Process

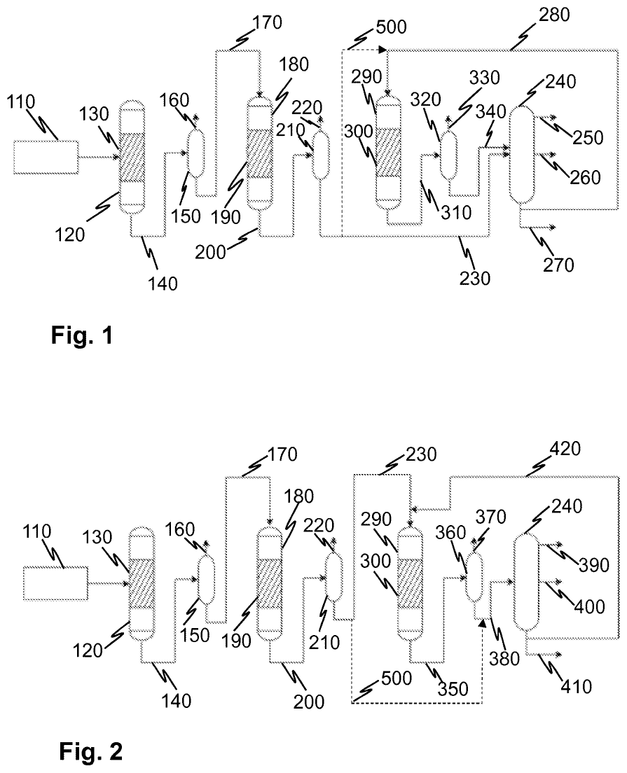

FIG. 1 schematically shows a process according to an example embodiment for producing the present hydrocarbon component. In FIG. 1, oxygenated hydrocarbon feed 110 is fed to a HDO reactor 120 in which it is subjected to hydrodeoxygenation in the presence of a HDO catalyst 130 to obtain a hydrodeoxygenation effluent (HDO effluent) 140, and the obtained HDO effluent 140 is subjected to gas-liquid separation 150 to separate from the HDO effluent at least compounds that are gaseous at NTP 160 to obtain a degassed HDO effluent 170, which is in this example embodiment the herein defined paraffinic hydrocarbon feed. The degassed HDO effluent 170 is in FIG. 1 then fed to a first reactor 180 in which the degassed HDO effluent 170 is subjected to hydroisomerisation in the presence of a hydroisomerisation catalyst 190 to obtain a hydroisomerisation effluent (HI effluent) 200, and the obtained HI effluent 200 is subjected to gas-liquid separation 210 to separate from the HI effluent 200 at least compounds that are gaseous at NTP 220 to obtain a degassed HI effluent 230. In FIG. 1, the degassed HI effluent 230 is fed to a distillation unit 240, that may comprise a single column, or prefractionation and main distillation columns, from which several streams or cuts are obtained. From the distillation in FIG. 1, a hydrocarbon component 270, e.g. as a diesel fuel component, and an aviation fuel component 260 and/or a gasoline fuel component 250 are recovered. A recycle stream 280 having a T5 boiling point of 270° C. or higher is also separated in the fractionation of FIG. 1, and the hydrocarbon component 270 may be separated as a portion therefrom. A second reaction section feed comprising the recycle stream 280 as the at least a portion of the HI effluent is in FIG. 1 fed to a second reactor 290 in which it is subjected to hydrocracking in the presence of a hydrocracking catalyst 300 to obtain a hydrocracking effluent 310. In FIG. 1, the hydrocracking effluent 310 is subjected to gas-liquid separation 320 to separate from the hydrocracking effluent 310 at least compounds that are gaseous at NTP 330 to obtain a degassed hydrocracking effluent 340, and the degassed hydrocracking effluent 340 is then fed as a co-feed with the degassed HI effluent 230 to the distillation unit 240 for fractionation. In certain embodiments yet another portion of the HI effluent 200, 230 may be fed as a co-feed 500 with the recycle stream 280, i.e. as part of the second reaction section feed, to hydrocracking in the second reactor 290.

FIG. 2 schematically shows a process according to another example embodiment for producing the present hydrocarbon component. In FIG. 2, oxygenated hydrocarbon feed 110 is fed to a HDO reactor 120 in which it is subjected to hydrodeoxygenation in the presence of a HDO catalyst 130 to obtain a hydrodeoxygenation effluent (HDO effluent) 140, and the obtained HDO effluent 140 is subjected to gas-liquid separation 150 to separate from the HDO effluent at least compounds that are gaseous at NTP 160 to obtain a degassed HDO effluent 170, which is in this example embodiment the herein defined paraffinic hydrocarbon feed as herein defined. The degassed HDO effluent 170 is then in FIG. 2 fed to a first reactor 180 in which the degassed HDO effluent 170 is subjected to hydroisomerisation in the presence of a hydroisomerisation catalyst 190 to obtain a hydroisomerisation effluent (HI effluent) 200. The obtained HI effluent 200 is subjected to gas-liquid separation 210 to separate from the HI effluent 200 at least compounds that are gaseous at NTP 220 to obtain a degassed HI effluent 230. In FIG. 2, a second reaction section feed comprising the degassed HI effluent 230 is fed to a second reactor 290 in which it is subjected to hydrocracking in the presence of a hydrocracking catalyst 300 to obtain a hydrocracking effluent 350, and the hydrocracking effluent 350 is subjected to gas-liquid separation 360 to separate from the hydrocracking effluent 350 at least compounds that are gaseous at NTP 370 to obtain a degassed hydrocracking effluent 380. In FIG. 2, the degassed hydrocracking effluent 380 is fed to a distillation unit 240, that may comprise a single column, or prefractionation and main distillation columns, where it is fractionated into several streams or cuts. From the distillation in FIG. 2, a hydrocarbon component 410 e.g. as a diesel fuel component, and an aviation fuel component 400 and/or a gasoline fuel component 390 are recovered. When a recycle stream 420, preferably having a T5 boiling point of 270° C. or higher, is separated, the hydrocarbon component 410 may be separated as a portion therefrom. In FIG. 2, the recycle stream 420 may be fed to the second reactor 290 to hydrocracking as a co-feed with the degassed HI effluent 230, i.e. as part of the second reaction section feed. In certain embodiments a portion of the HI effluent 200, 230 may be fed as a co-feed 500 with the hydrocracking effluent 350, 380 to the fractionation.

### EXAMPLES

### Example 1—Production of Present Hydrocarbon Components

The hydrocarbon components studied herein were recovered from test runs, where four different hydrocracking (HC) feeds (feed A, B, C, and D) were obtained by subjecting two different types of fatty feedstocks to hydrodeoxygenation (HDO) and gas-liquid separation to obtain paraffinic hydrocarbon feed comprising >95 wt-% paraffins based on the total weight of the paraffinic hydrocarbon feed, said paraffinic hydrocarbon feed further subjected to hydroisomerisation (HI) of different severity. A fraction of the hydroisomerisation effluent obtained by degassing the hydroisomerisation effluent, or by recovery of just a bottom fraction, was hydrocracked, followed by degassing or degassing and stabilising the effluent from hydrocracking. A renewable aviation fuel component was recovered from the thus obtained hydrocracking effluent as the main product, and at least a hydrocarbon component as a further product of particular interest here. The thus obtained hydrocarbon components were renewable hydrocarbon components. Details of the hydrocracking feeds are given in Table 1, and Table 2 shows process details for the hydrocracking as well as approximate boiling point ranges and yields of the hydrocarbon components.

TABLE 1
Details of the hydrocracking feeds.

| | HC Feed B | HC Feed A | | |
|---|---|---|---|---|
| | Animal fat/ | Animal fat/ | | |
| | vegetable oil | vegetable oil | | HC Feed D |
| | base subjected | base subjected | HC Feed C | Animal fat/ |
| | to HDO, high | to HDO, low | Heavy vegetable | vegetable oil |
| | severity HI, | severity HI, | oil/animal fat | base subjected |
| | degassing, and | degassing, and | base subjected | to HDO, medium |
| | recovery of | recovery of | to HDO, medium | severity HI, |
| | bottom fraction | bottom fraction | severity HI, and | degassing, and |
| | as HC feed | as HC feed | degassing | stabilising |
| Cloud point, ° C. | −30 | −11 | −27 | −34 |
| (ASTM D 5771- | | | | |
| 17) | | | | |
| Density at | 788 | 786 | 779 | 780 |
| 15° C., kg/m³ | | | | |
| (EN ISO 12185- | | | | |
| 1996) | | | | |
| IBP to FBP, ° C. | 284 to 327 | 286 to 317 | 78 to 344 | 200 to 305 |
| (ENISO3405- | | | | |
| 2019) | | | | |
| T5; T10 to T90, ° C. | 292; 293 to 300 | 294; 295 to 301 | 208; 251 to 323 | 247; 261 to 293 |
| (ENISO3405- | | | | |
| 2019) | | | | |
| Paraffins, wt-% | nP 3 wt-%; total | nP 13 wt-%; | nP 5 wt-%; total | nP 4 wt-%; total |
| (GC × GC-FID/ | iP 97 wt-%; | total iP 87 wt-%; | iP 94 wt-%; | iP 95 wt-%; |
| GC × GC-MS) | multi-iP 64 wt-%; | multi-iP 23 wt-%; | multi-iP 59 wt-%; | multi-iP 53 wt-%; |
| | C15-C18 (each | C15-C18 (each | C15-C22 (each | C15-C18 |
| | present): 94 wt-% | present): 96 wt-% | present): 88 wt-% | (each present): |
| | in total | in total | in total | 89 wt-% in total |

TABLE 2
Process details for test run conditions in hydrocracking, cloud points of degassed
hydrocracking effluents, approximate boiling point ranges and yields of the
hydrocarbon components (NC) (as wt-% of the degassed HC effluent).

| | | | Effluent's | | Approx. NC | NC |
|---|---|---|---|---|---|---|
| Test | HC | | cloud | Yield of | boiling point | sample |
| Run | Feed | HC conditions | point, ° C. | NC, wt-% | range | code |
| 8 | A | 348° C., 40 bar, WHSV | −78 | 16.9 | ca 300° C. to | NC_TR8 |
| | | 0.8 1/h, H₂ 300 nL/L | | | FBP | |
| 15 | B | 348° C., 40 bar, WHSV | −79 | 14.9 | ca 300° C. to | NC_TR15 |
| | | 0.8 1/h, H₂ 300 nL/L | | | FBP | |
| 7 | B | 348° C., 40 bar, WHSV | −79 | 28.4 | ca 300° C. to | NC_TR7 |
| | | 1.3 1/h, H₂ 300 nL/L | | | FBP | |
| 2 | C | 330° C., 40 bar, WHSV | −43 | 59.7 | ca 300° C. to | NC_TR2 |
| | | 1.3 1/h, H₂ 360 nL/L | | | FBP | |
| 3 | C | 345° C., 40 bar, WHSV | −57 | 48.4 | ca 285° C. to | NC_TR3 |
| | | 1.3 1/h, H₂ 360 nL/L | | | FBP | |
| 6 | C | 350° C., 40 bar, WHSV | <−95 | 27.7 | ca 285° C. to | NC_TR6 |
| | | 0.6 1/h, H₂ 450 nL/L | | | FBP | |
| 1 | D | 330° C., 40 bar, WHSV | −47 | 52.8 | ca 285° C. to | NC_TR1 |
| | | 1.3 1/h, H₂ 360 nL/L | | | FBP | |

The hydrocracking catalyst was a non-sulphided bifunctional hydrocracking catalyst comprising Pt on a zeolite/zeolite-type material in all test runs. When the feeds reported in Table 1 were subjected to the hydrocracking conditions reported in Table 2, said catalyst had not just cracking but also isomerizing activity.

The hydrocarbon components were recovered in good yields, generally the yields being higher at lower hydrocracking temperature, at higher WHSV and/or with heavier hydrocracking feed.

### Example 2—Composition and Characteristics of Present Hydrocarbon Components

Some physico-chemical and compositional characteristics of hydrocarbon components of Example 1 were analyzed and are compiled in Table 3, Table 4 and Table 5. Hydrocracking feed HC Feed B and two conventional renewable paraffinic diesels (reference renewable diesels, RRD) obtained by subjecting a fatty feedstock to HDO and hydroisomerisation, and recovery of diesel fraction, i.e. without subjecting to hydrocracking, were used as reference here.

TABLE 3
Some physico-chemical characteristics of the hydrocarbon components of Example 1.

| | Sample | | | | | | |
|---|---|---|---|---|---|---|---|
| | NC_TR15 | NC_TR8 | NC_TR7 | NC_TR2 | NC_TR3 | NC_TR6 | NC_TR1 |
| | Feed | | | | | | |
| | Feed A | Feed B | Feed B | Feed C | Feed C | Feed C | Feed D |
| Approx. | 300 | 300 | 300 | 285 | 285 | 285 | 285 |
| distillation | | | | | | | |
| start, ° C. | | | | | | | |
| Density, | 790 | 793 | 792 | 790 | 791 | 791 | 787 |
| kg/m³ (EN | | | | | | | |
| ISO 12185- | | | | | | | |
| 1996) | | | | | | | |
| Cloud | −47 | −44 | −42 | −35 | −43 | −64 | −39 |
| point, ° C. | | | | | | | |
| (ASTM D | | | | | | | |
| 5771-17) | | | | | | | |
| Viscosity at | 3.933 | 4.368 | 4.222 | 4.290 | 4.211 | 4.035 | 3.668 |
| 40° C., | | | | | | | |
| mm²/s (EN | | | | | | | |
| ISO 3104- | | | | | | | |
| 2020) | | | | | | | |
| Cetane | 71.1 | n.a. | n.a. | 74.3 | 72.2 | 68.3 | 73.4 |
| number- | | | | | | | |
| IQT (ASTM | | | | | | | |
| D6890-16) | | | | | | | |
| Aromatics, | n.a. | n.a. | n.a. | 0.2 | 0.4 | 0.4 | <0.2 |
| wt-% | | | | | | | |
| (EN12916) | | | | | | | |

n.a. = not analysed

TABLE 4
Some compositional characteristics of HC Feed B, RRD 1, RRD2 and hydrocarbon
components of Example 1, as determined by GC × GC-FID/GC × GC-MS.

| | HC | | | NC_{—} | NC_{—} | NC_{—} | NC_{—} | NC_{—} | NC_{—} |
|---|---|---|---|---|---|---|---|---|---|
| Sample | Feed B | RRD1 | RRD2 | TR8 | TR7 | TR2 | TR3 | TR6 | TR1 |
| C15 iso- | 0.1 | 10.3 | 8.6 | 0.0 | 0.0 | 0.0 | 0.0 | 0.0 | 0.0 |
| paraffins, wt-% | | | | | | | | | |
| C16 iso- | 1.9 | 24.1 | 20.2 | 0.0 | 0.0 | 3.2 | 3.6 | 3.0 | 5.8 |
| paraffins, wt-% | | | | | | | | | |
| C17 iso- | 9.9 | 19.7 | 19.5 | 12.3 | 9.3 | 15.1 | 13.8 | 2.1 | 15.7 |
| paraffins, wt-% | | | | | | | | | |
| C18 iso- | 79.5 | 30.5 | 30.9 | 64.6 | 71.5 | 47.9 | 50.9 | 69.9 | 73.5 |
| paraffins, wt-% | | | | | | | | | |
| C19 iso- | 0.8 | 0.6 | 0.8 | 9.2 | 6.8 | 1.5 | 0.7 | 1.5 | 0.4 |
| paraffins, wt-% | | | | | | | | | |
| C20 iso- | 2.8 | 0.0 | 0.0 | 3.7 | 3.2 | 5.8 | 6.5 | 5.0 | 1.7 |
| paraffins, wt-% | | | | | | | | | |
| C21 iso- | 0.3 | 0.0 | 0.0 | 1.6 | 1.2 | 6.3 | 4.5 | 3.9 | 0.1 |
| paraffins, wt-% | | | | | | | | | |
| C22 iso- | 0.5 | 0.0 | 0.0 | 0.9 | 0.7 | 16.7 | 16.8 | 12.0 | 0.4 |
| paraffins, wt-% | | | | | | | | | |
| total C15-C22 i- | 95.9 | 85.2 | 80.0 | 92.3 | 92.7 | 96.5 | 96.7 | 97.5 | 97.6 |
| paraffins, wt-% | | | | | | | | | |
| total n-paraffins, | 3.4 | 6.2 | 13.1 | 2.8 | 3.2 | 1.4 | 1.3 | 1.1 | 1.7 |
| wt-% | | | | | | | | | |
| wt-ratio of C15- | 28.2 | 17.6 | 7.1 | 33.7 | 29.7 | 68.9 | 72.2 | 92.3 | 57.4 |
| C22 i-paraffins | | | | | | | | | |
| to C15-C22 n- | | | | | | | | | |
| paraffins | | | | | | | | | |
| C15-C22 mono- | 30.0 | n.a. | n.a. | 27.2 | 25.4 | 16.0 | 9.0 | 5.3 | 18.7 |
| iP, wt-% | | | | | | | | | |
| C15-C22 multi- | 65.9 | n.a. | n.a. | 65.1 | 67.4 | 80.5 | 87.7 | 92.2 | 78.9 |
| iP, wt-% | | | | | | | | | |
| C19-C22 multi- | 3.7 | n.a. | n.a. | 10.8 | 8.3 | 28.2 | 26.9 | 22.0 | 2.2 |
| iP, wt-% | | | | | | | | | |
| wt-ratio of C15- | 2.2 | n.a. | n.a. | 2.4 | 2.7 | 5.0 | 9.7 | 17.4 | 4.2 |
| C22 multi-iP to | | | | | | | | | |
| C15-C22 mono- | | | | | | | | | |
| iP | | | | | | | | | |

TABLE 5
Distillation characteristics of HC Feed B and hydrocarbon
components of Example 1 by EN ISO 3405-2019.

| Sample | HC | | | | |
|---|---|---|---|---|---|
| code | Feed B | NC_TR2 | NC_TR3 | NC_TR6 | NC_TR1 |
| IBP, ° C. | 284.1 | 283.3 | 284.2 | 281.3 | 276.7 |
| T5, ° C. | 292.2 | 293.0 | 291.4 | 287.5 | 287.6 |
| T10, ° C. | 292.7 | 294.1 | 291.8 | 288.2 | 288.1 |
| T20, ° C. | 293.1 | 295.4 | 293.2 | 289.2 | 288.6 |
| T50, ° C. | 294.6 | 299.9 | 297.7 | 292.4 | 290.1 |
| T70, ° C. | 295.9 | 306.3 | 303.8 | 296.7 | 291.4 |
| T80, ° C. | 297.3 | 312.5 | 310.0 | 300.9 | 292.5 |
| T90, ° C. | 300.2 | 323.8 | 322.2 | 309.9 | 294.6 |
| T95, ° C. | 308.2 | 334.1 | 334.6 | 320.3 | 298.1 |
| FBP, ° C. | 326.9 | 342.8 | 342.3 | 326.7 | 307.5 |
| T95 − T5, ° C. | 16 | 41 | 43 | 33 | 11 |

Some variation due to the process conditions, targeted distillation cut point start, and/or using different HC feeds in the test runs can be seen. However, as can be summarized based on Table 3, the cloud point (and CFPP) temperatures varied from −35° C. down to −64° C., kinematic viscosity at 40° C. varied within a range from 3.668 mm²/s to 4.368 mm²/s, the measured cetane numbers were >68, and the components had high densities with just slight variation (787-793 kg/m³).

From Table 4 it can be seen that hydrocarbon components of Example 1 contained mainly C15-C22 paraffins having isoparaffins as the dominant fraction (>96 wt-%). As to the carbon numbers, the dominant i-paraffins were C18 i-paraffins, and more specifically C18 i-paraffins having two or more branches (data not reported here). Depending on the process conditions from about 48 wt-% to about 75 wt-% of all paraffins were C18 i-paraffins. The weight ratio of C15-C22 i-paraffins to C15-C22 n-paraffins of hydrocarbon components of Example 1 was >22, i.e. far higher than the ratio in the HC Feed B used as reference here. Further, compared to the HC Feed B and RRDs, hydrocarbon components of Example 1 had lower contents of total n-paraffins, lower contents of mono-branched i-paraffins, <30 wt-%, and higher contents of multiple-branched i-paraffins, >65 wt-%.

### Example 3—Comparison of Physico-Chemical Characteristics of Present Hydrocarbon Components (NC), a Hydrocracking Feed and Paraffinic Reference Renewable Diesels (RRDs)

The following comparisons demonstrate that the present hydrocarbon component (NC) clearly differs from the hydrocracking feed (HC feed B) and from the two conventional paraffinic renewable diesels (same reference renewable diesels, RRDs, as in the previous example). Table 6 shows some physico-chemical characteristics of the HC feed B, RRD 1 and RRD2, as well as of two hydrocarbon components obtained from test runs 3 and 8 (NC_TR3, NC_TR8), average properties (Average NC) of five hydrocarbon components according to the present disclosure obtained from five different test runs (TRs) hydrocracking HC Feed B under different HC conditions, and average properties (Average NC) of three components according to the present disclosure obtained from three different test runs (TRs) hydrocracking HC Feed C under different HC conditions.

TABLE 6
Properties of the HC feed B, RRD 1 and RRD 2, hydrocarbon components NC_TR3 and NC_{—}
TR8, and average properties of hydrocarbon components (Average NC) from 5 and 3 different TRs.

| | | | | | | Average NC | Average NC |
|---|---|---|---|---|---|---|---|
| | | | | | | from 5 | from 3 |
| | HC | | | | | different TRs | different TRs |
| | Feed | RRD | RRD | NC_{—} | NC_{—} | using HC | using HC |
| Sample | B | 1 | 2 | TR3 | TR8 | Feed B | Feed C |
| Cloud point, ° C. | −30 | −33 | −16 | −43 | −44 | −40 | −47 |
| (ASTM D 5771- | | | | | | | |
| 17) | | | | | | | |
| Viscosity at 40° | 3.892 | 2.966 | 3.085 | 4.211 | 4.368 | 4.244 | 4.179 |
| C., mm²/s (*) | | | | | | | |
| Viscosity at 0° | n.a. | n.a. | n.a. | 14.48 | 15.17 | n.a. | n.a. |
| C., mm²/s (*) | | | | | | | |
| Viscosity at −20° | n.a. | n.a. | n.a. | 38.64 | 40.04 | n.a. | n.a. |
| C., mm²/s (*) | | | | | | | |
| Viscosity at −40° | n.a. | n.a. | n.a. | 175.3 | n.a. | n.a. | n.a. |
| C., mm²/s (*) | | | | | | | |
| Cetane number | 82.8 | 75.8 | 82.0 | 72.2 | n.a. | n.a. | 71.6 |
| (ASTM D6890- | | | | | | | |
| 16) | | | | | | | |
| Density at 15° | 788 | 780 | 781 | 791 | 793 | 792 | 791 |
| C., kg/m³ (EN | | | | | | | |
| ISO 12185- | | | | | | | |
| 1996) | | | | | | | |
| Flash point, ° C. | >110 | 69 | 89 | >110 | >110 | >110 | >110 |
| (**) | | | | | | | |

*EN ISO 3104-2020;
**ISO 2719-2016 (Pensky-Martens closed cup procedure)

The results of Table 6 show that hydrocarbon components with excellent low cloud points, increased kinematic viscosities at 40° C. and high densities are obtainable with various test run conditions, from different HC feeds. Individual and averaged cloud points of the new components were at least about 10° C. lower than those of the hydrocracking feed and RRDs. The individual and averaged kinematic viscosities at 40° C. of the present hydrocarbon components were significantly higher than those of the RRDs, but also clearly higher than viscosity of the hydrocracking feed. Cetane numbers of the new components were approximately at the same level as for the hydrocracking feed and RRDs, and clearly exceeding the cetane requirement of at least 51.0 for Class B paraffinic diesels, and even the cetane requirement of at least 70.0 for Class A paraffinic diesels (EN 15940-2016). The individual and averaged densities of the present hydrocarbon components were significantly higher than the density of RRDs, and also clearly higher than the density of the HC feed B.

### Example 4—Blending Experiments With Arctic Grade Fossil Diesel

Already the physico-chemical characteristics of Example 3 suggested the present hydrocarbon component an excellent blending component, particularly for diesel fuel compositions. In these blending examples the suitability of the present hydrocarbon component for arctic/severe winter diesel grades is demonstrated. As reference components, a conventional paraffinic renewable diesel (reference renewable diesel, RRD) and a conventional fossil arctic grade diesel were used. The blending examples are linearly calculated using the properties of pure blending components (NC_TR8, RRD, and fossil arctic grade).

TABLE 7
Results of blending experiments.

| | | | | 10% | 10% | 25% | 25% |
|---|---|---|---|---|---|---|---|
| | | | Fossil | NC + | RRD + | NC + | RRD + |
| | NC_{—} | | arctic | 90% | 90% | 75% | 75% |
| Property | TR8 | RRD | grade (ag) | ag** | ag** | ag** | ag** |
| Cloud point, ° C. | −44 | −33 | −42 | −42.2 | −41.1 | −42.4 | −39.9 |
| (ASTM D 5771- | | | | | | | |
| 17) | | | | | | | |
| Viscosity at 40° | 4.368 | 2.966 | 1.731 | 1.995 | 1.855 | 2.390 | 2.040 |
| C., mm²/s (EN | | | | | | | |
| ISO 3104-2020) | | | | | | | |
| Density at | 793 | 780 | 818 | 815 | 814 | 812 | 808 |
| 15° C., kg/m³ (EN | | | | | | | |
| ISO 12185- | | | | | | | |
| 1996) | | | | | | | |
| Calorific value | 34.9* | 34.3* | 35.2 | 35.2 | 35.1 | 35.1 | 35.0 |
| (MJ/L) | | | | | | | |

*Assumed that calorific value for NC and RRD was 44.0 MJ/kg.
**Percentages given as vol-% of the total volume of the blend.

For example, when 10 vol-% of NC_TR8 was blended with fossil arctic grade diesel a viscosity (at 40° C.) of almost 2 mm²/s could be obtained. This viscosity was clearly higher than the viscosity achieved by blending 10 vol-% of RRD with fossil arctic grade diesel.

Moreover, when the blend contained 25 vol-% NC_TR8, the viscosity advantages became even more obvious compared to the case when RRD was used as a blend component. Furthermore, when NC_TR8 was used as a blending component the cloud point of the arctic grade diesel did not increase, unlike when RRD was used as a blending component, to the contrary, due to the very low cloud point of the NC-TR8, it was actually possible to lower the cloud point of the arctic grade diesel.

According to diesel specification for climate-related requirements for arctic or severe winter climates (EN590:2022 Table 3), Class 4 diesel should have cloud point max. −34° C., density at 15° C. within a range from 800 to 840 kg/m³, kinematic viscosity at 40° C. within a range from 1.200 to 4.000, cetane number within EU min. 51.0, and as distillation characteristics max. 10.0 vol-% recovered at 180° C. and min. 95.0 vol-% recovered at 340° C. While the density of the present hydrocarbon component(s) (NC) tested herein is slightly lower than 800 kg/m³, the other mentioned characteristics are well within the Class 4 specification, and thus allow incorporation of the present hydrocarbon component(s) into arctic/winter diesel fuel compositions in far greater proportions than for example the paraffinic reference renewable diesels (RRDs) tested herein.

Furthermore, the examples showed that using NC as a blending component instead of RRD, higher calorific values per liter could be reached for the blends. This is a major advantage as it directly leads to lower fuel consumption.

Various embodiments have been presented. It should be appreciated that in this document, words comprise, include, and contain are each used as open-ended expressions with no intended exclusivity. The foregoing description has provided by way of non-limiting examples of particular implementations and embodiments a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1-23. (canceled)

24. A hydrocarbon component comprising:
n-paraffins, mono-branched i-paraffins, and multiple-branched i-paraffins; wherein
a sum amount of C15-C22 n-paraffins, C15-C22 mono-branched i-paraffins, and C15-C22 multiple-branched i-paraffins is at least 90 wt-% of a total hydrocarbon component weight; and wherein:
a weight ratio of C15-C22 i-paraffins to C15-C22 n-paraffins is at least 22:1, and/or at least 24:1, and/or at least 30:1, and/or at least 34:1.

25. The hydrocarbon component according to claim 24, wherein a sum amount of C1-C14 hydrocarbons is at most 3 wt-% of the total hydrocarbon component weight.

26. The hydrocarbon component according to claim 24, wherein a sum amount of total n-paraffins is at most 5 wt-%, and/or at most 3 wt-% of the total hydrocarbon component weight.

27. The hydrocarbon component according to claim 24, wherein a weight ratio of C15-C22 multiple-branched i-paraffins to C15-C22 mono-branched i-paraffins is at least 1.8, and/or at least 2.0, and/or at least 2.5.

28. The hydrocarbon component according to claim 24, wherein a sum amount of C15-C22 i-paraffins is at least 80 wt-%, and/or at least 85 wt-%, and/or at least 90 wt-%, and/or at least 95 wt-% of the total hydrocarbon component weight; and/or
wherein a sum amount of C15-C22 multiple-branched i-paraffins is at least 60 wt-%, and/or at least 63 wt-%, and/or at least 65 wt-% of the total hydrocarbon component weight; and/or
a sum amount of C15-C22 mono-branched i-paraffins is at most 35 wt-%, and/or at most 30 wt-%, and/or at most 25 wt-% of the total hydrocarbon component weight; and/or
wherein the sum amount of C15-C22 n-paraffins, C15-C22 mono-branched i-paraffins and C15-C22 multiple-branched i-paraffins is at least 92 wt-%, and/or at least 95 wt-%, and/or from 95 to 99 wt-% of the total hydrocarbon component weight.

29. The hydrocarbon component according to claim 24, wherein the hydrocarbon component has a difference between T95 temperature (95 vol-% recovered, EN ISO 3405-2019) and T5 temperature (5 vol-% recovered, EN ISO 3405-2019) of at most 70° C., and/or at most 65° C., and/or at most 60° C.; and/or at least 10° C., and/or at least 15° C., and/or at least 25° C.; and/or
within a range from 10° C. to 70° C., and/or from 15° C. to 70° C., and/or from 20° C. to 70° C., and/or from 25° C. to 65° C.

30. The hydrocarbon component according to claim 24, wherein the hydrocarbon component has a kinematic viscosity at 40° C. of more than 3.0 mm²/s, and/or more than 3.9 mm²/s, and/or at least 4.0 mm²/s, as determined according to EN ISO 3104-2020; and/or
wherein the hydrocarbon component has a kinematic viscosity at −20° C. within a range from 20 to 100 mm²/s, and/or from 30 to 50 mm²/s, and/or from 30 to 45 mm²/s, as determined according to EN ISO 3104-2020.

31. The hydrocarbon component according to claim 24, wherein the hydrocarbon component has a flash point of 100° C. or higher, and/or 110° C. or higher, and/or 135° C. or higher, as determined according to ISO 2719-2016 (Pensky-Martens closed cup procedure).

32. The hydrocarbon component according to claim 24, wherein the hydrocarbon component has a density at 15° C. at least 780 kg/m³, and/or at least 785 kg/m³, and/or at least 790 kg/m³, as determined according to EN ISO 12185-1996.

33. The hydrocarbon component according to claim 24, wherein the hydrocarbon component has a cloud point of −32° C. or lower, and/or −35° C. or lower, and/or, 40° C. or lower, as determined according to ASTM D 5771-17.

34. The hydrocarbon component according to claim 24, wherein the hydrocarbon component has a biogenic carbon content, as determined according to EN 16640 (2017), of at least 50 wt-%, and/or at least 70 wt-%, and/or at least 90 wt-%, and/or about 100 wt-% based on the total weight of carbon (TC) in the hydrocarbon component.

35. The hydrocarbon component according to claim 24, obtained by a process comprising:
providing a paraffinic hydrocarbon feed, obtained by hydrodeoxygenation of an oxygenated hydrocarbon feed including vegetable oils, animal fats, and/or microbial oils and optionally followed by gas-liquid separation and/or paraffinic feed fractionation(s); and
subjecting the paraffinic hydrocarbon feed to at least hydroisomerisation, and/or to hydroisomerisation and hydrocracking, followed by fractionation, and recovering from the fractionation at least the hydrocarbon component.

36. The hydrocarbon component according to claim 24, obtained by a process comprising:
providing a paraffinic hydrocarbon feed including at least 60 wt-% paraffins, based on a total weight of the paraffinic hydrocarbon feed, and at most 30 wt-% paraffins based on a total weight of the paraffins in the paraffinic hydrocarbon feed;
subjecting the paraffinic hydrocarbon feed in a first reaction section, in a first reactor, to hydroisomerisation in a presence of a hydroisomerisation catalyst to obtain a hydroisomerisation effluent;
subjecting a second reaction section feed including at least a portion of the hydroisomerisation effluent to hydrocracking in a second reaction section, in a second reactor, in a presence of a hydrocracking catalyst to obtain a hydrocracking effluent; and
subjecting the hydrocracking effluent, and optionally a portion of the hydroisomerisation effluent, to fractionation, and recovering from the fractionation at least the hydrocarbon component, and optionally an aviation fuel component.

37. The hydrocarbon component according to claim 24, wherein the hydrocarbon component is a diesel fuel component, and/or an arctic grade diesel fuel component; and/or
wherein a cetane number of the hydrocarbon component is at least 51, and/or at least 65, and/or at least 68, and/or at least 70, and/or at least 74, as determined according to EN 15195-2014.

38. The hydrocarbon component according to claim 24 in a diesel fuel composition, wherein
the hydrocarbon component is 1 to 99 vol-%, and/or from 10 to 70 vol-% of a total volume of the diesel fuel composition.

39. The hydrocarbon component according to claim 24 in a diesel fuel composition, wherein the hydrocarbon component is configured to improve one or more product properties of the diesel fuel composition, said one or more product properties of the diesel fuel composition including at least one or more of kinematic viscosity at 40° C., cloud point, cold filter plugging point, cetane number, density, calorific value, and/or biogenic carbon content.

40. The hydrocarbon component according to claim 38 in a diesel fuel composition, wherein the diesel fuel composition is configured to fulfil requirements for diesel fuels set in Directive 2009/30/EC, and optionally in EN590:2022.

41. The hydrocarbon component according to claim 24 in a feedstock(s) for industrial conversion process(es), a thermal cracking feedstock(s) and/or in a catalytic cracking feedstock(s), in transformer oil(s), in heat-transfer medium or media, in switchgear oil(s), in shock absorber oil(s), in insulating oil(s), in hydraulic fluid(s), in gear oil(s), in transmission fluid(s), in degreasing composition(s), in penetrating oil(s), in anticorrosion composition(s), in multipurpose oil(s), in metal working fluid(s), in rolling oil(s), in rolling oils for aluminum, in cutting oil(s), in drilling fluid(s), in solvent(s), in lubricant(s), in extender oil(s), in carrier(s), in dispersant composition(s), in demulsifier(s), in extractant(s), in paint composition(s), in coating fluid(s) or paste(s), in adhesive(s), in resin(s), in varnish(es), in printing paste(s) or ink(s), in detergent(s), in cleaner(s), in plasticizing oil(s), in turbine oil(s), in hydrophobization composition(s), in agriculture, in crop protection fluid(s), in construction, in concrete demoulding formulation(s), in electronics, in medical appliance(s), in composition(s) for car, electrical, textile, packaging, paper, cosmetic and/or pharmaceutical industry; and/or
in any intermediate(s) therefore.

42. The hydrocarbon component according to claim 24,
the hydrocarbon component is additized with at least one or more of antioxidant(s), stabilizer(s), detergent(s), corrosion inhibitor(s), friction modifier(s), metal deactivator(s), lubricating additive(s), antifoaming agent(s), and/or fuel dye(s).

43. The hydrocarbon component according to claim 39 in a diesel fuel composition, wherein the diesel fuel composition is configured to fulfil requirements for diesel fuels set in Directive 2009/30/EC, and in EN590:2022; and/or
wherein the hydrocarbon component according to claim 24 is in an amount from 1 to 99 vol-%, and/or from 10 to 70 vol-% of a total volume of the diesel fuel composition.
